(19) United States
(12) Patent Application Publication
(10) Pub. No.: US 2023/0108461 A1
(43) Pub. Date: Apr. 6, 2023

(54) VIRTUAL DEVICE ASSIGNMENT FRAMEWORK

(71) Applicant: Intel Corporation, Santa Clara, CA (US)

(72) Inventors: Shaopeng HE, Shanghai (CN); Anjali Singhai JAIN, Portland, OR (US); Yadong LI, Portland, OR (US); Eliel LOUZOUN, Jerusalem (IL); Bradley A. BURRES, Newton, MA (US); Utkarsh Y. KAKAIYA, Folsom, CA (US); Kun TIAN, Shanghai (CN); Baolu LU, Shanghai (CN); Yan ZHAO, Shanghai (CN); Madhusudan CHITTIM MUNIRATHNAM, Portland, OR (US); Lingyu LIU, Shanghai (CN)

(21) Appl. No.: 18/072,544

(22) Filed: Nov. 30, 2022

(30) Foreign Application Priority Data
Jun. 7, 2022 (WO) PCT/CN2022/097397

(51) Int. Cl. G06F 9/455

(52) U.S. Cl. CPC G06F 9/45558; G06F 9/45545; G06F 2009/45579; G06F 2009/45595

(57) ABSTRACT

Examples described herein relate to circuitry configured to generate at least one virtual device interface to utilize the processor circuitry and provide the at least one virtual device interface to a server to assign to a process to provide the process with capability to utilize the processor circuitry. In some examples, the processor circuitry is to perform one or more of local area network access, cryptographic processing, and/or storage access. In some examples, the storage access comprises access to one or more Non-volatile Memory Express (NVMe) devices.

### RELATED APPLICATION

This application claims the benefit of priority to Patent Cooperation Treaty (PCT) Application No. PCT/CN2022/097397 filed Jun. 7, 2022. The entire contents of that application are incorporated by reference.

### BACKGROUND

Single Root I/O Virtualization (SR-IOV) and Sharing specification, version 1.0 (2007) by the Peripheral Component Interconnect (PCI) Special Interest Group (PCI-SIG), provided hardware-assisted high performance I/O virtualization and sharing of PCI Express devices. Intel® Scalable IOV (SIOV) is an input/output (I/O) virtualization specification, and part of the Open Compute Project, that markedly expands current Peripheral Component Interconnect Express (PCIe) device number limitations to increase a number of containers or services that can utilize a PCIe device.

### BRIEF DESCRIPTION OF THE DRAWINGS

FIG. 1 depicts an example system.

FIG. 2 depicts an SIOV system.

FIG. 3 depicts an example system for virtual device discovery and a driver framework.

FIG. 4 depicts an example of operations for allocating virtual devices to an application or other process.

FIG. 5 depicts an example of a data structure.

FIG. 6 depicts an example profile.

FIG. 7 depicts an example data structure.

FIG. 8 depicts an example data structure.

FIG. 9A depicts an example data structure.

FIG. 9B depicts an example data structure.

FIG. 10 depicts an example process.

FIG. 11 depicts an example network interface device.

FIG. 12 depicts an example system.

FIG. 13 depicts an example system.

### DETAILED DESCRIPTION

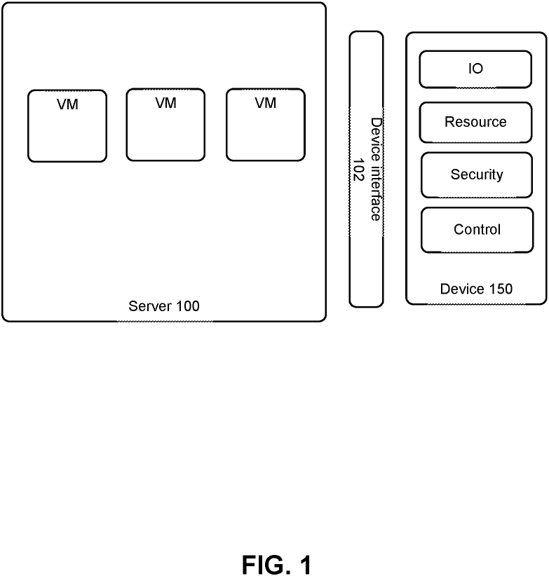

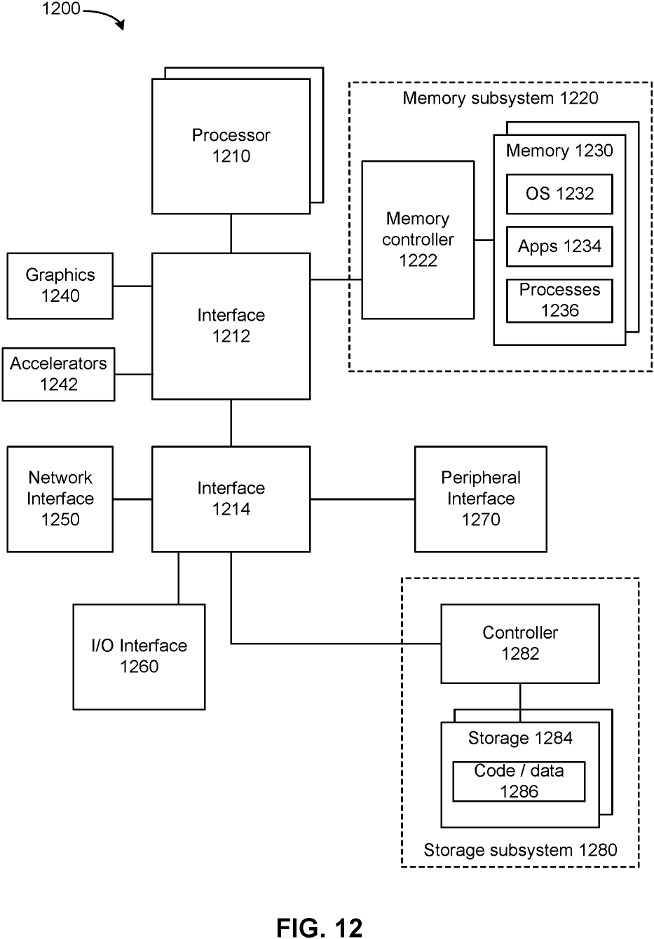

FIG. 1 depicts an example system. One or more processors of host server system 100 can execute multiple virtual machines (VMs) or other virtual execution environments that utilize circuitry of device 150. An example of a host system is described at least with respect to FIG. 12. Server 100 can be communicatively coupled to device 150 using device interface 102. Device interface 102 can provide communications between server 100 and device 150 based on PCIe, Compute Express Link® (CXL), Universal Chiplet Interconnect Express (UCIe), or others.

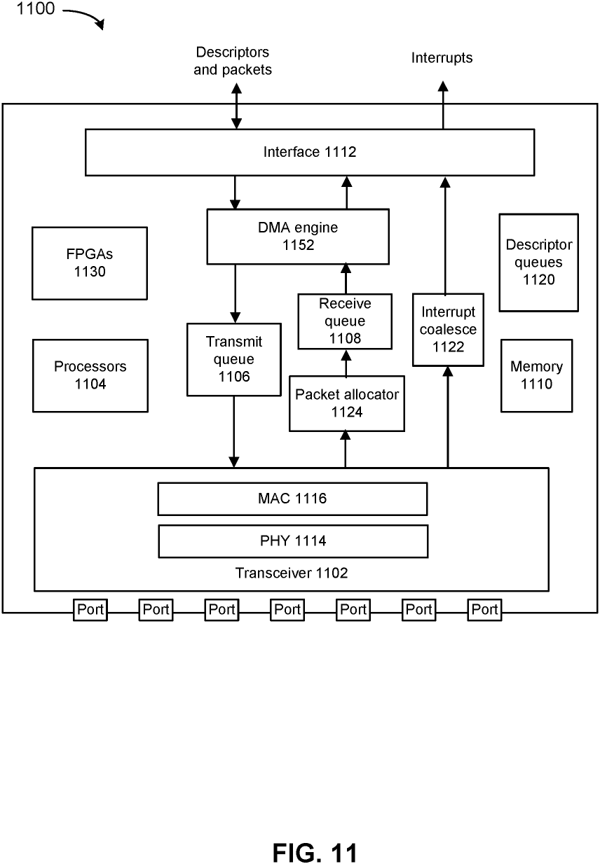

Device 150 can include memory, accelerator circuitry, a network interface device, or others. Examples of device 150 are described at least with respect to FIGS. 11, 12, and/or 13. Device 150 may include circuitry to perform virtual switch operations, manage storage transactions (e.g., compression, cryptography, virtualization), and manage operations performed on other network interface devices, compute nodes, servers, and/or devices. In some examples, device 150 may be accessed as a virtual device by one or more VMs using scalable input/output virtualization (SIOV), SR-IOV, or other technologies.

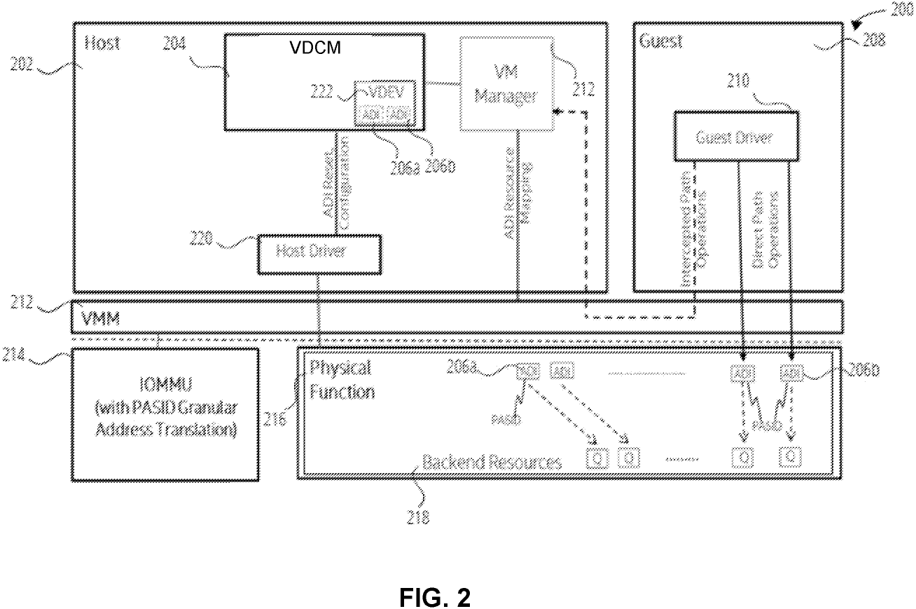

FIG. 2 depicts a system consistent with SIOV. Host operating system (OS) 202 may include a host driver 220 and guest OS 208 may include a guest driver 210. As shown, host OS 202 may include Virtual Device Composition Module (VDCM) 204 which may compose a virtual device (VDEV) 222 for guest OS 208. In some examples, VDEV 222 may include virtual capability registers configured to expose device (or “device-specific”) capabilities to one or more virtual machines or other virtual execution environments.

Virtual capability registers may be accessed by guest driver 210 of device 110 to determine device capabilities associated with VDEV 222. VDEV 222 may include one or more assignable device interfaces (ADIs), including an ADI 206a and an ADI 206b. An ADI may be assigned, for instance, by mapping the ADIs 206a-206b into a memory managed input output (MMIO) space of VDEV 222. An ADI can refer to one or more circuitries or resources 218 of device 150 that are allocated, configured, and organized as an isolated unit to share utilization of device 150. For example, if device 150 is a network interface device, ADIs 206a-206b may provide backend resources 218 that include transmit queues and receive queues associated with a virtual switch interface. As another example, if device 150 is a storage device, ADIs 206a-206b may provide backend resources 218 that include command queues and completion queues associated with a storage namespace. As yet another example, if device 150 is a graphics processing unit (GPU), ADIs 206a-206b may provide backend resources 218 that include dynamically created graphics or compute contexts.

Input-output memory management unit (IOMMU) 214 may be configured to perform memory management operations, including address translations between virtual memory spaces and physical memory. As shown, IOMMU 214 may support translations at the Process Address Space ID (PASID) level. A PASID may be assigned to one or more of a plurality of processes executing on the host hardware 104 (e.g., processes associated with guest OS 208 and/or VMs) to permit sharing of device 150 across multiple processes while providing at least one process with a complete virtual address space.

VDCM 204 can perform device management and configuration operations. VDCM 204 can compose one or more virtual device (VDEV) 404 instances utilizing one or more ADIs. Accesses between a service (e.g., container, virtual machine, or other virtual execution environment) and a hardware device are either direct path or intercepted path, where direct path operations are mapped directly to the underlying device hardware. The VDCM or a virtual machine manager (VMM) can manage intercepted path operations. Intercepted path operations can include device management operations such as initialization, control, configuration, quality of service (QoS) handling, and error processing. A device (e.g., device 150) can utilize a specific VDCM and intercepted path manager installed and maintained in host computing system. The VDCM may be implemented in the host operating system or in kernel space. However, configuration of kernel space can reduce the infrastructure stability and increase platform security risk.

Some examples provide a virtual device discovery and driver framework at least for SIOV whereby a host system executes an ADI subsystem in kernel space but a device executes a VDCM and performs intercepted path operations. The VDCM can create ADIs for assignment to a VM or container, or other virtual execution environment and the ADI subsystem can dispatch and assign ADIs to VM or container ADI drivers. A VM ADI driver can provide a VM with access and utilization of the device whereas a container ADI driver can provide a container with access and utilization of the device. Formats for ADI PCIe Extended Capability, ADI Manager Profile, VDCM capabilities, and ADI Entry are utilized in order to permit a virtual device to utilize one or more VDCM capabilities (e.g., 8 or a different number of capabilities).

Some examples provide a SIOV ADI discovery process and ADI passthrough formats (e.g., Virtual Function I/O (VFIO) for VM and Unified/User-space-access-intended Accelerator Framework (UACCE) for a container). A device can add an extended PCIe capability and a memory range for a ADI table to physical function (PF) Base Address Register (BAR) space and use embedded software (e.g., VDCM) to update the table according to an agreed ADI format with hardware or emulated registers and interrupt resources.

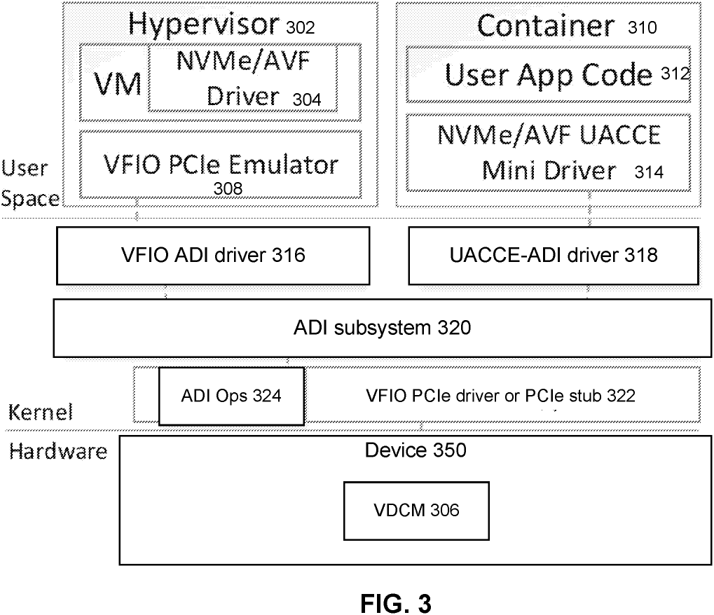

FIG. 3 depicts an example system for virtual device discovery and a driver framework in SIOV for VMs and containers. The system can include various process and software executed by one or more processors in one or more servers. Various examples of device 350 include one or more of: a network interface device, other devices can be used instead or in addition, such as a storage controller, memory controller, fabric interface, processor, and/or accelerator device. In some examples, execution of VDCM 306 and intercepted path operations can be offloaded to device 350. VDCM 306 can compose one or more virtual device (VDEV) instances utilizing one or more Assignable Device Interfaces (ADIs). ADIs can provide access to at least one of multitudes of local area networks (LANs), Non-volatile Memory Express (NVMe) devices, security circuitry (e.g., encryption or decryption), accelerators, and other circuitry of device 350 so that VMs or containers to share use of circuitry of device 350. ADI subsystem 320 can receive identifications of different virtual devices, such as VDEV 334, from VDCM 306 executed by device. VDEV 334 may be associated with one or more virtual capability registers, one or more ADIs, and so forth. ADI subsystem 320 can access VDCM 306 executed by device as PCIe extended capability. At least one example of a PCIe extended capability is described at least in PCIe version 4.0, section 7.5 (2011), as well as revisions and variations thereof. ADI subsystem 320 and related Linux kernel drivers can be utilized, so devices (e.g., device 350) can leverage ADI subsystem 320 and related Linux kernel drivers to passthrough its ADI to user space applications without vendor logic added to host kernel.

Device 350 can include circuitry configured to perform intercepted path operations such as initialization, control, configuration, quality of service (QoS) handling, and error processing.

Host system 300 can execute hypervisor 302 to manage execution of at least one VM. At least one VM may utilize device driver 304 to access device 350. Hypervisor 302 may further access a virtual function I/O (VFIO) PCIe emulator 308. Host system 300 can execute container 310, which may include a user application 312 and driver 314. Hypervisor 302, at least one VM, and/or container 310 may execute in user space. User space can be memory allocated to running applications and some drivers. Processes running under user space may have access to a limited part of memory, whereas the kernel may have access to all of the memory.

Host system 300 can execute VFIO ADI driver 316, Unified/User-space-access-intended Accelerator Framework (UACCE) ADI driver 318, ADI subsystem 320, and driver 322 in kernel space. Kernel space can be memory allocated to the kernel, kernel extensions, some device drivers and the operating system. Kernel space can be a location where the code of the kernel is stored and executes within.

ADI operations (ops) 324 can provide application program interfaces (APIs) for at least one driver to plug into ADI subsystem 320. APIs can include get_capability, get_version, etc.

VFIO ADI driver 316 may correspond to a driver for device 350. VFIO ADI driver 316 can use a device template to compose a virtual Adaptive Virtual Function (AVF) device using a mapping between an ADI and the register addresses in the ADI entry. VFIO ADI driver 316 can provide VM access to device 350 via an ADI (virtual device). VFIO ADI driver 316 can implement VFIO user space interfaces based on different ADIs.

UACCE driver 318 can provide container with access to device via an ADI (virtual device). UACCE ADI driver 318 can provide Shared Virtual Addressing (SVA) between container 310 and device 350, allowing a device (e.g., device 350 and/or an accelerator component of or connected to device 350) to access data structures in host 300. Because of the unified address space provided by the UACCE ADI driver 318, device 350 and container 310 can share the same virtual addresses when communicating.

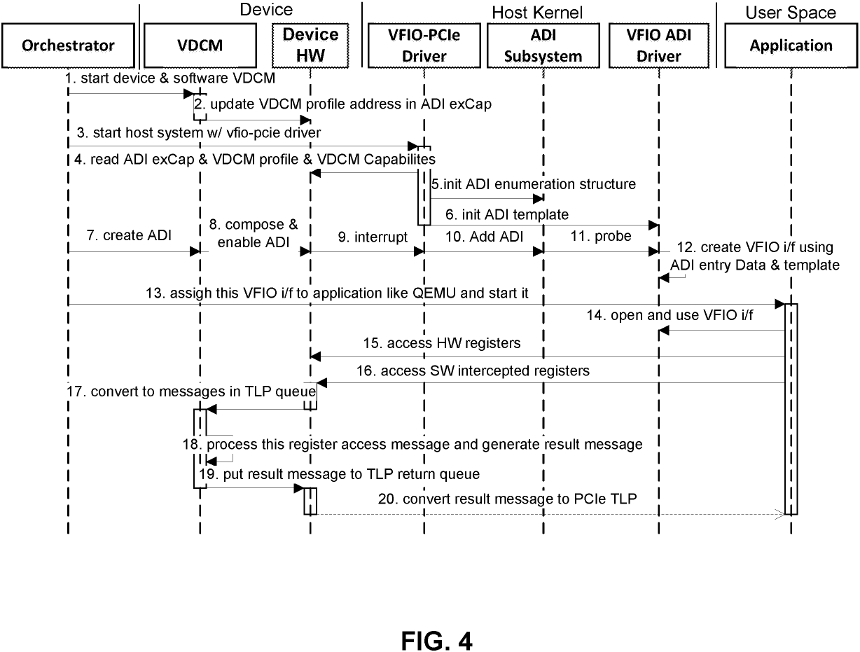

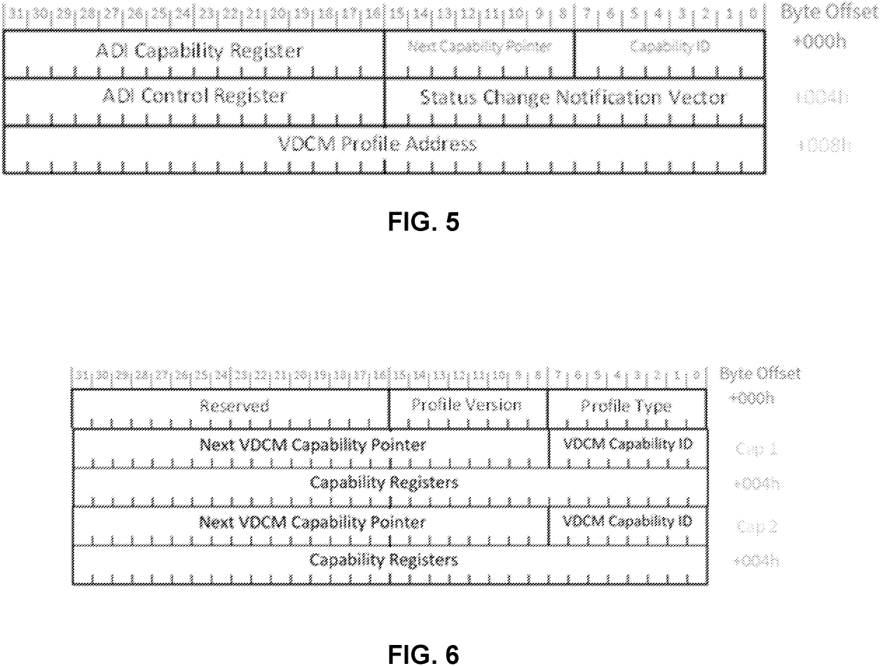

FIG. 4 depicts an example of operations for allocating virtual devices to an application or other process. At 1, an orchestrator can request a device to start and execute VDCM as software and/or firmware. At 2, the VDCM can update an VDCM profile address in ADI extended capability data structure (e.g., FIG. 5). At 3, the orchestrator can start a host system with VFIO PCIe driver (e.g., driver 322) in host kernel in order to provide an interface between an ADI subsystem and device (e.g., device 350). At 4, the VFIO PCIe driver can read VDCM capabilities in VDCM profile. For example, FIG. 6 depicts an example of ADI Manager profile and VDCM capabilities and includes at least two VDCM capability IDs.

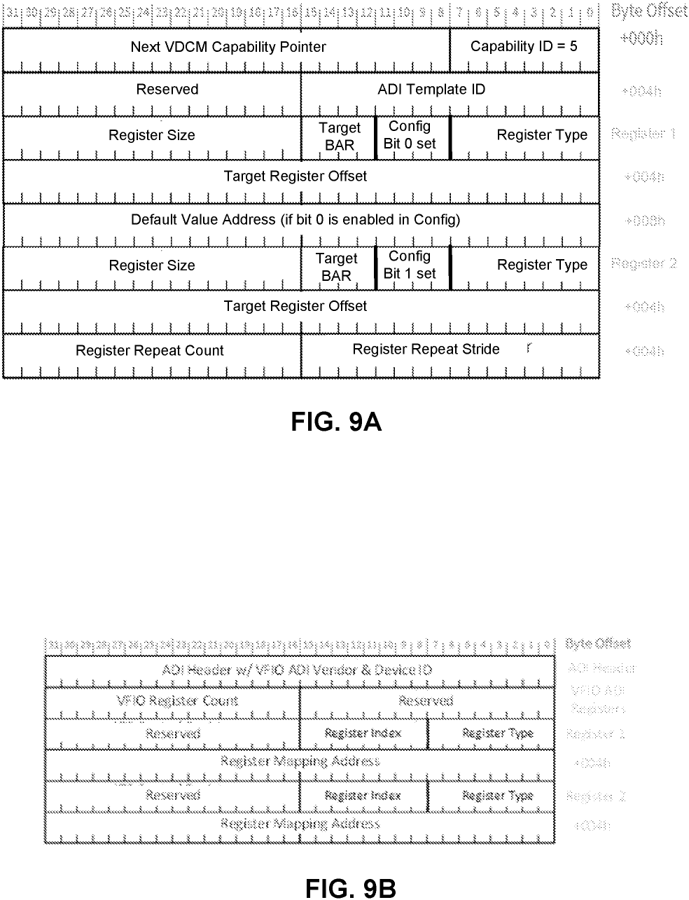

At 5, the VFIO PCIe driver can initialize ADI subsystem in host kernel to enumerate capabilities associated with a particular ADI that can be used by container or VM. For example, enumerated capabilities can include virtual devices or ADI entries. FIG. 9A depicts an example of ADI entry. At 6, the VFIO PCIe driver can initialize an ADI template (e.g., FIG. 9A) to identify common attributes of different types of ADIs.

At 7, the container can request the VDCM to create an ADI. At 8, the VDCM can compose and enable a particular ADI for the device. At 9, the device can issue an interrupt to the VFIO PCIe driver to indicate a created ADI is available for assignment or dispatch by the ADI subsystem. At 10, the VFIO PCIe driver can identify the created ADI to the ADI subsystem. At 11, the ADI subsystem can issue a probe to the VFIO ADI driver to indicate that a device is available to utilize. At 12, the VFIO ADI driver can create a VFIO interface using a template (e.g., FIG. 9A) and ADI entry data (e.g., FIG. 9B). For example, VFIO ADI driver can compose a virtual AVF device using the mapping register address from ADI entry using an AVF template.

At 13, the container can assign the VFIO interface to an application in user space and start the application. An example application can include QEMU, hypervisor, software that creates and runs virtual machines (VMs) or containers, applications based on Data Plane Development Kit (DPDK), and so forth. The VFIO interface could be a form of PCIe device, and use standard PCIe configuration space in VFIO_PCI_CONFIG_REGION_INDEX region and standard BAR 0 in VFIO_PCI_BAR0_REGION_INDEX region and so on. If this VFIO interface is not in a standard form of PCIe device, a user space emulator can emulate a standard PCIe device based on an agreed format data in VFIO regions.

At 14, the application can access the VFIO interface to commence utilization of the device resources associated with the assigned ADI and VFIO interface. At 15, the application can access hardware registers associated with the ADI. At 16, the application can access software emulated registers in the device to prepare for processing of intercepted path operations. At 17, the VDCM can translate PCIe Transaction Layer Packet (TLP) to vendor specific message to prepare for processing of intercepted path operations. At 18, in response to a request to perform intercepted path operation, the VDCM can process a vendor specific message in software emulated registers and generate a result message. At 19, the VDCM can put a result message into a TLP return queue. At 20, the device can convert the result message to PCIe TLP for access by the application.

A device performing an embedded VDCM has a PCIe standard extended capability or Designated Vendor Specific Extended Capability (DVSEC) to bridge a host ADI subsystem and embedded VDCM. VDCM can use VFIO PCIe driver and ADI subsystem as this bridge.

FIG. 5 depicts an example of a data structure for ADI Extended Capability (Ex Cap). The data can represent PCIe capabilities of a PCIe device and can be stored in a memory or register of host or device. Table 1 below shows example register field descriptions.

TABLE 1

ADI Extended Capability Registers

| Register Name | Example Register Description |
|---|---|
| Control Register | Bit 0 - 7: 8 Doorbell Triggers, reverse original value is a trigger. Other bits reserved |
| Capability Register | Bit 0: Doorbell status, different value than software doorbell trigger means device is in progress of previous trigger. Bit 1: 0 for 32 bits offset, 1 for all offset registers are 64 bits Other bits reserved |
| Capability ID | Identifies Extended Capability |
| Status Change Notification vector | One interrupt vector for VDCM to send notification to host when a configuration change occurs to VDCM or related. Notification Vector enables embedded VDCM to send interrupts when VDCM or ADI table have changes. |
| VDCM Profile Address | BAR address of where VDCM writes ADI Manager profile and VDCM capabilities (e.g., FIG. 6 ). |

FIG. 6 depicts an example profile that can be generated by VDCM and stored in memory or register of host or device. PCIe capabilities of the device can be updated to refer to the profile of FIG. 6 (e.g., operation 2 of FIG. 4). VDCM can share capability information with ADI subsystem executed by host using the profile of FIG. 6.

An ADI Manager profile can refer to one or more VDCM capabilities depending on device implementations which are chained together like a PCIe capability. A capability can utilize one or more registers. Host ADI subsystem may support different VDCM capabilities. Capability negotiation between host and device can be performed.

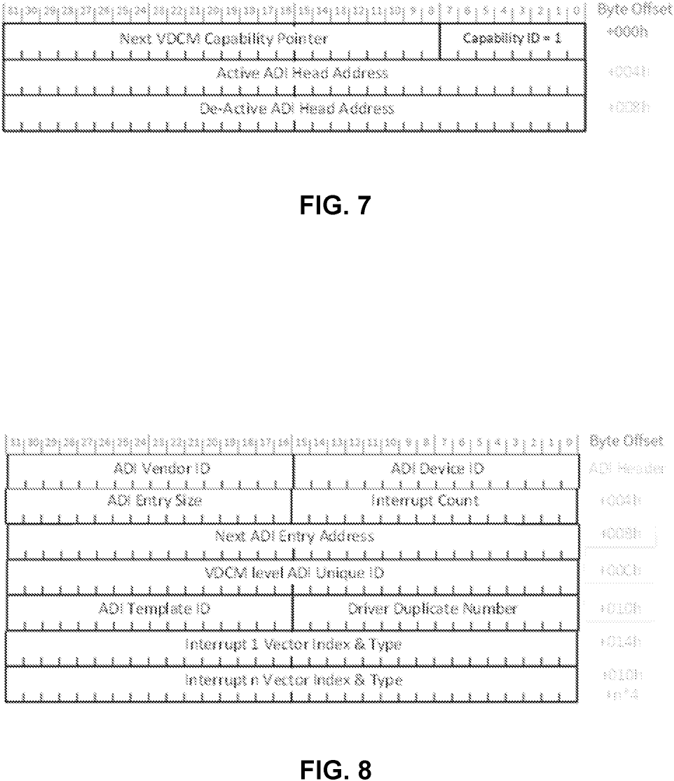

FIG. 7 depicts an example ADI Table and ADI Enumeration that can utilize the profile of FIG. 6. The ADI Table and ADI Enumeration can be generated by a VDCM (e.g., ADI manager). For example, ADI information stored in table can be used in operation 10 of FIG. 4 to add an ADI to ADI subsystem or delete an ADI used by the ADI subsystem. In particular, the table or data structure can be used to identify active and deleted ADIs. Active ADI head address points to the latest ADI entry just being composed or updated. De-Active head address points to the latest ADI entry being deactivated.

For an example ADI of a SIOV virtual device (vDev), VDCM (e.g., ADI manager) can compose and store the ADI table and share the ADI table with ADI subsystem according to VDCM capabilities such as Chained ADI Enumeration described with respect to FIG. 8. For example, an Active ADI head address can point to an ADI entry of FIG. 8.

FIG. 8 depicts an example ADI Entry and Header Format. A VDCM (e.g., ADI manager) can generate the template of ADI Entry and Header Format. ADI Entry and Header can be stored in host and/or device. An ADI entry can include a header with next ADI entry address in a chain of ADI entries. Interrupt resources can be enumerated for ADI subsystem to generate VFIO or other interfaces, including Interrupt message storage (IMS) and software interrupts. ADI template ID can be used for some ADI drivers like VFIO to define the interface layout such as: PCIe Configuration and Status Register (CSR), BAR0, BAR3 etc.

Table 2 depicts an example of ADI Entry Header fields.

TABLE 2

| | |
|---|---|
| Register Name | Example Register Description |
| ADI Vendor ID | PCIe Vendor ID |
| ADI Device ID | PCIe Device ID |
| ADI Entry Size | Total size of the entry including ADI Vendor ID to ADI Device Specific Data |
| Interrupt Count | Interrupt Vector count for registers start from offset +014 h |
| Next ADI Entry | next ADI entry address for Active ADI chain or De-Active ADI chain. |
| VDCM Level ADI Unique ID | One unique ID (UID 32 b) in VDCM level assigned by cloud orchestrator which may have another 32 b UID for each VDCM. Total a 64 b orchestrator level UID. 32 b only for DOCUMENT, might be 64 b in final SPEC |
| ADI Template ID | Same template ID defined in VFIO ADI template capability or other ADI template capability if applied |
| Driver Duplicate Number | For Shared Work Queue (SWQ) usage, one hardware ADI could create multiple user space interfaces |
| Interrupt Vector | 32 bits vector Index & Type |

FIG. 9A depicts an example VFIO ADI capability template. A VDCM (e.g., ADI manager) can generate the VFIO ADI capability template and store the template into host and/or device. This capability template can define the layout of target virtual device such as Intel® AVF for VFIO ADI driver to emulate such device. One VDCM profile can have multiple such template capability instances, e.g., one for AVF and one for NVMe, each has one VDCM level unique template ID which ADI entry can refer to.

VFIO ADI capability template can define register type, offset, size and default value for PCIe configuration and BAR spaces. VFIO ADI driver can use this template and ADI entry data to generate a fully functional virtual PCIe device for user space applications (e.g., VM or container) to use. This capability can enable PCIe device emulation to be done in VFIO ADI driver in a configurable way without coding in VDCM or hypervisor.

VFIO ADI driver can process ADI entry data according to ADI template, register by register. If the register in ADI entry data does not match with the one in template for the same register index and type, ADI creation can fail. If one register in template has a default value and does not have an overwriting mapping in ADI entry, ADI driver can use default value.

Table 3 depicts examples of register contents.

TABLE 3

VFIO ADI Template Registers

| | |
|---|---|
| Register Name | Example Register Description |
| ADI Template ID | VDCM level unique ID for ADI entry to refer to this template |
| Register Size | The size for this template register |
| Target BAR | VFIO index for the emulated BAR of this template register, like configuration space is VFIO_PCI_CONFIG_REGION_INDEX, BAR 0 is VFIO_PCI_BAR0_REGION_INDEX |
| Config | Bit 0 is set for having default value field for this register, other bits are reserved Bit 1 is set for repeat registers like Queue Registers in AVF device which has one set of registers for each Queue |
| Register Type | Resource type defined in section ADI resource type |
| Target Register offset | The register offset in the emulated BAR |
| Default Value | Default value for this template register, if no value existing in ADI entry, this value will be used when VFIO ADI driver composing the ADI instance. This field exists only when config bit 0 is set |
| Register Repeat Count | Ceiling repeat count for current register. VFIO ADI entry does not necessary provide all repeat in the beginning. E.g., AVF virtual device may has maximum 16 queues, but in the beginning as the default only 4 queues’ related registers are populated in ADI entry. VFIO ADI driver will only map those 4 queue registers but leave other register space as page fault. Later, when VM AVF driver dynamically allocate more queues using Admin Command, VDCM can fill in other queue register mapping address in ADI entry and notify ADI subsystem to reload this ADI and solve that page fault for VM to use those new queues and for additional interrupt vectors. Makes space for ADI entry for maximum capability. If this ADI table size becomes a concern for HW MMIO implementation, such ADI table is possible to put into host memory too. Embedded VDCM just need to update them remotely via PCIe transaction. Field can exists when config bit 1 is set. |
| Register Repeat Stride | Repeat stride for current register’s target BAR offset, next register target BAR offset = current offset + stride Field can exist when config bit 1 is set. |

FIG. 9B depicts an example VFIO ADI Entry Body. VDCM (e.g., ADI manager) can generate the VFIO ADI Entry Body and store the entry in host and/or device. The ADI entry body can be pointed-to by active ADI head address of FIG. 7. VFIO ADI driver provides data in a VFIO ADI entry and access to applications via a VFIO interface. VFIO ADI driver can implement VFIO user space interfaces based on ADI entries.

Table 4 depicts an example of ADI Entry Body fields.

TABLE 4

| | |
|---|---|
| Register Name | Example Register Description |
| VFIO Register Count | Total number of VFIO registers are encapsulated in this ADI entry |
| Register index | The template register entry index begins with 1 in Error! Reference source not found. Register index points to a register template defined in VFIO ADI Template Capability referred by ADI template ID in ADI header |
| Region Type | Should be same one with corresponding entry in template |
| Register Mapping Address | The register address in PF BAR to be used for this ADI. BAR index and offset in PF BARs |

VFIO ADI driver can use a device template like AVF template to compose one virtual AVF device using the mapping register address from ADI entry. For an example of AVF requests, see Table 7-1 of Intel® Ethernet Adaptive Virtual Function (AVF) Hardware Architecture Specification (HAS) (2018). AVF protocol uses one Admin Queue to setup I/O Queue for actual networking packets sending and receiving. AVF SIOV uses mediate software to replace hardware for two slow path functions: PCIe configuration space and Admin Queue.

As implemented using mdev framework, AVF ADI for a network interface device can include dynamic hardware register pages (VDEV_MBX_START, VDEV_QRX_TAIL_START, VDEV_QTX_TAIL_START, VDEV_INT_DYN_CTL01, VDEV_INT_DYN_CTL) to be composited into AVF BAR0.

To leverage proposed ADI discovery mechanism, AVF PCIe configuration and BAR space could be implemented using ADI template capability. One example AVF ADI template in Table 5 uses a hardware register and software register for embedded VDCM with TLP Queue feature.

TABLE 5

Example of VFIO ADI Entry Body

| | Register Type | Register Index | Mapping offset | Example Description |
|---|---|---|---|---|
| Configuration Space | Omnipotent Software | 1 | Allocated by VDCM | 0xFFF |
| QTX_TAIL 1 | Hardware register | 2 | 0x04000000 | For AVF I/O TX Queue 1 |
| QTX_TAIL 2 | Hardware register | 2 | 0x04001000 | For AVF I/O TX Queue 2 |
| QTX_TAIL 3 | Hardware register | 2 | 0x04002000 | For AVF I/O TX Queue 3 |
| QTX_TAIL 4 | Hardware register | 2 | 0x04003000 | For AVF I/O TX Queue 4 |
| QRX_TAIL 1 | Hardware register | 3 | 0x03800000 | For AVF I/O RX Queue 1 |
| QRX_TAIL 2 | Hardware register | 3 | 0x03801000 | For AVF I/O RX Queue 2 |
| QRX_TAIL 3 | Hardware register | 3 | 0x03802000 | For AVF I/O RX Queue 3 |
| QRX_TAIL 4 | Hardware register | 3 | 0x03803000 | For AVF I/O RX Queue 4 |
| MBX_REG | Omnipotent Software | 4 | Allocated by VDCM | 1 page for Mailbox registers |
| DYN CTLN | Omnipotent Software | 5 | Allocated by VDCM | 4 pages for I/O queues vectors and 1 page for Mailbox queue vector |
| Reset register | Omnipotent Software | 6 | Allocated by VDCM | 1 page for reset register |

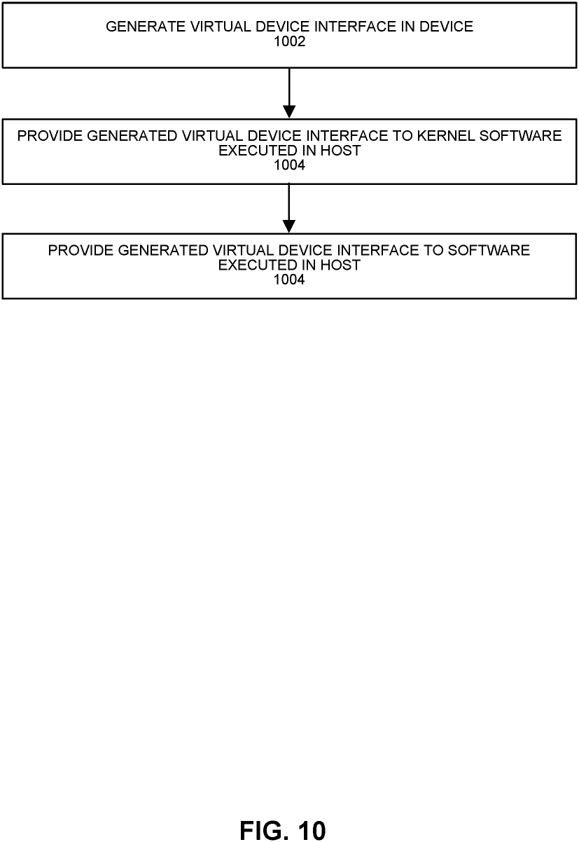

FIG. 10 depicts an example process. The process can be performed by a network interface device and server. At 1002, at least one virtual device interface can be generated at a device. The at least one virtual device interface can provide access to utilization processor circuitry of the device. In some examples, the device includes a network interface device. In some examples, a Virtual Device Composition Module (VDCM), consistent with Open Compute Project Scalable IOV (SIOV), can generate the at least one virtual device interface. In some examples, the at least one virtual device interface includes at least one assignable device interface (ADI), consistent with Open Compute Project Scalable IOV (SIOV).

At 1004, the at least one virtual device interface can be provided to software executed by a server. At 1006, the software can assign the at least one virtual device to a process to provide the process with capability to utilize the processor circuitry. For example, the server can execute an ADI subsystem in kernel space to receive the generated at least one virtual device and assign the at least one virtual device to the process.

FIG. 11 depicts an example network interface device. In some examples, processors 1104 and/or FPGAs 1140 can be configured to generate and provide virtual device interfaces to a virtual device interface subsystem (e.g., ADI subsystem) for assignment to a process and intercept path operations, as described herein. Some examples of network interface 1100 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 1100 can include transceiver 1102, processors 1104, transmit queue 1106, receive queue 1108, memory 1110, and bus interface 1112, and DMA engine 1152. Transceiver 1102 can be capable of receiving and transmitting packets in conformance with the applicable protocols such as Ethernet as described in IEEE 802.3, although other protocols may be used. Transceiver 1102 can receive and transmit packets from and to a network via a network medium (not depicted). Transceiver 1102 can include PHY circuitry 1114 and media access control (MAC) circuitry 1116. PHY circuitry 1114 can include encoding and decoding circuitry (not shown) to encode and decode data packets according to applicable physical layer specifications or standards. MAC circuitry 1116 can be configured to perform MAC address filtering on received packets, process MAC headers of received packets by verifying data integrity, remove preambles and padding, and provide packet content for processing by higher layers. MAC circuitry 1116 can be configured to assemble data to be transmitted into packets, that include destination and source addresses along with network control information and error detection hash values.

Processors 1104 can be one or more of: combination of: a processor, core, graphics processing unit (GPU), field programmable gate array (FPGA), application specific integrated circuit (ASIC), or other programmable hardware device that allow programming of network interface 1100. For example, a “smart network interface” or SmartNIC can provide packet processing capabilities in the network interface using processors 1104.

Processors 1104 can include a programmable processing pipeline or offload circuitries that is programmable by P4, Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 904 can be configured to generate and provide virtual device interfaces to a virtual device interface subsystem (e.g., ADI subsystem) for assignment to a process and intercept path operations, as described herein.

Packet allocator 1124 can provide distribution of received packets for processing by multiple CPUs or cores using receive side scaling (RSS). When packet allocator 1124 uses RSS, packet allocator 1124 can calculate a hash or make another determination based on contents of a received packet to determine which CPU or core is to process a packet.

Interrupt coalesce 1122 can perform interrupt moderation whereby interrupt coalesce 1122 waits for multiple packets to arrive, or for a time-out to expire, before generating an interrupt to host system to process received packet(s). Receive Segment Coalescing (RSC) can be performed by network interface 1100 whereby portions of incoming packets are combined into segments of a packet. Network interface 1100 provides this coalesced packet to an application.

Direct memory access (DMA) engine 1152 can copy a packet header, packet payload, and/or descriptor directly from host memory to the network interface or vice versa, instead of copying the packet to an intermediate buffer at the host and then using another copy operation from the intermediate buffer to the destination buffer.

Memory 1110 can be volatile and/or non-volatile memory device and can store any queue or instructions used to program network interface 1100. Transmit traffic manager can schedule transmission of packets from transmit queue 1106. Transmit queue 1106 can include data or references to data for transmission by network interface. Receive queue 1108 can include data or references to data that was received by network interface from a network. Descriptor queues 1120 can include descriptors that reference data or packets in transmit queue 1106 or receive queue 1108. Bus interface 1112 can provide an interface with host device (not depicted). For example, bus interface 1112 can be compatible with or based at least in part on PCI, PCIe, PCI-x, Serial ATA, and/or USB (although other interconnection standards may be used), or proprietary variations thereof.

FIG. 12 depicts a system. The system can use embodiments described herein to generate and provide virtual device interfaces to a virtual device interface subsystem (e.g., ADI subsystem) for assignment to a process as well as intercept path operations, as described herein. System 1200 includes processors 1210, which provides processing, operation management, and execution of instructions for system 1200. Processors 1210 can include any type of microprocessor, central processing unit (CPU), graphics processing unit (GPU), XPU, processing core, or other processing hardware to provide processing for system 1200, or a combination of processors. An XPU can include one or more of: a CPU, a graphics processing unit (GPU), general purpose GPU (GPGPU), and/or other processing units (e.g., accelerators or programmable or fixed function FPGAs). Processors 1210 controls the overall operation of system 1200, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 1210 can include one or more processor sockets.

In some examples, interface 1212 and/or interface 1214 can include a switch (e.g., CXL switch) that provides device interfaces between processors 1210 and other devices (e.g., memory subsystem 1220, graphics 1240, accelerators 1242, network interface 1250, and so forth). Connections provide between a processor socket of processors 1210 and one or more other devices can be configured by a switch controller, as described herein.

In one example, system 1200 includes interface 1212 coupled to processors 1210, which can represent a higher speed interface or a high throughput interface for system components that needs higher bandwidth connections, such as memory subsystem 1220 or graphics interface components 1240, or accelerators 1242. Interface 1212 represents an interface circuit, which can be a standalone component or integrated onto a processor die.

Accelerators 1242 can be a programmable or fixed function offload engine that can be accessed or used by a processors 1210. For example, an accelerator among accelerators 1242 can provide compression (DC) capability, cryptography services such as public key encryption (PKE), cipher, hash/authentication capabilities, decryption, or other capabilities or services. In some embodiments, in addition or alternatively, an accelerator among accelerators 1242 provides field select controller capabilities as described herein. In some cases, accelerators 1242 can be integrated into a CPU socket (e.g., a connector to a motherboard or circuit board that includes a CPU and provides an electrical interface with the CPU). For example, accelerators 1242 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1242 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1220 represents the main memory of system 1200 and provides storage for code to be executed by processors 1210, or data values to be used in executing a routine. Memory subsystem 1220 can include one or more memory devices 1230 such as read-only memory (ROM), flash memory, one or more varieties of random access memory (RAM) such as DRAM, or other memory devices, or a combination of such devices. Memory 1230 stores and hosts, among other things, operating system (OS) 1232 to provide a software platform for execution of instructions in system 1200. Additionally, applications 1234 can execute on the software platform of OS 1232 from memory 1230. Applications 1234 represent programs that have their own operational logic to perform execution of one or more functions. Applications 1234 and/or processes 1236 can refer instead or additionally to a virtual machine (VM), container, microservice, processor, or other software. Processes 1236 represent agents or routines that provide auxiliary functions to OS 1232 or one or more applications 1234 or a combination. OS 1232, applications 1234, and processes 1236 provide software logic to provide functions for system 1200. In one example, memory subsystem 1220 includes memory controller 1222, which is a memory controller to generate and issue commands to memory 1230. It will be understood that memory controller 1222 could be a physical part of processors 1210 or a physical part of interface 1212. For example, memory controller 1222 can be an integrated memory controller, integrated onto a circuit with processors 1210.

In some examples, OS 1232 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others. In some examples, OS 1232 and/or a driver can configure network interface 1250 to generate and provide virtual device interfaces to a virtual device interface subsystem (e.g., ADI subsystem) for assignment to a process as well as intercept path operations, as described herein.

While not specifically illustrated, it will be understood that system 1200 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1200 includes interface 1214, which can be coupled to interface 1212. In one example, interface 1214 represents an interface circuit, which can include standalone components and integrated circuitry. In one example, multiple user interface components or peripheral components, or both, couple to interface 1214. Network interface 1250 provides system 1200 the ability to communicate with remote devices (e.g., servers or other computing devices) over one or more networks. Network interface 1250 can include an Ethernet adapter, wireless interconnection components, cellular network interconnection components, USB (universal serial bus), or other wired or wireless standards-based or proprietary interfaces. Network interface 1250 can transmit data to a device that is in the same data center or rack or a remote device, which can include sending data stored in memory. Network interface 1250 can receive data from a remote device, which can include storing received data into memory.

In some examples, network interface 1250 can be implemented as a network interface controller, network interface card, a host fabric interface (HFI), or host bus adapter (HBA), and such examples can be interchangeable. Network interface 1250 can be coupled to one or more servers using a bus or other device interface (e.g., PCIe, Compute Express Link (CXL), Universal Chiplet Interconnect Express (UCIe), or other connection technologies). See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof.

Network interface 1250 may be embodied as part of a system-on-a-chip (SoC) that includes one or more processors, or included on a multichip package that also contains one or more processors. Some examples of network device 1250 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1200 includes one or more input/output (I/O) interface(s) 1260. I/O interface 1260 can include one or more interface components through which a user interacts with system 1200 (e.g., audio, alphanumeric, tactile/touch, or other interfacing). Peripheral interface 1270 can include any hardware interface not specifically mentioned above. Peripherals refer generally to devices that connect dependently to system 1200. A dependent connection is one where system 1200 provides the software platform or hardware platform or both on which operation executes, and with which a user interacts.

In one example, system 1200 includes storage subsystem 1280 to store data in a nonvolatile manner. In one example, in certain system implementations, at least certain components of storage 1280 can overlap with components of memory subsystem 1220. Storage subsystem 1280 includes storage device(s) 1284, which can be or include any conventional medium for storing large amounts of data in a nonvolatile manner, such as one or more magnetic, solid state, or optical based disks, or a combination. Storage 1284 holds code or instructions and data 1286 in a persistent state (e.g., the value is retained despite interruption of power to system 1200). Storage 1284 can be generically considered to be a “memory,” although memory 1230 is typically the executing or operating memory to provide instructions to processors 1210. Whereas storage 1284 is nonvolatile, memory 1230 can include volatile memory (e.g., the value or state of the data is indeterminate if power is interrupted to system 1200). In one example, storage subsystem 1280 includes controller 1282 to interface with storage 1284. In one example controller 1282 is a physical part of interface 1214 or processors 1210 or can include circuits or logic in processors 1210 and interface 1214.

In an example, system 1200 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-volatile Memory Express (NVMe) over Fabrics (NVMe-oF) or NVMe.

In some examples, system 1200 can be implemented using interconnected compute nodes of processors, memories, storages, network interfaces, and other components. High speed interconnects can be used such as PCIe, Ethernet, or optical interconnects (or a combination thereof).

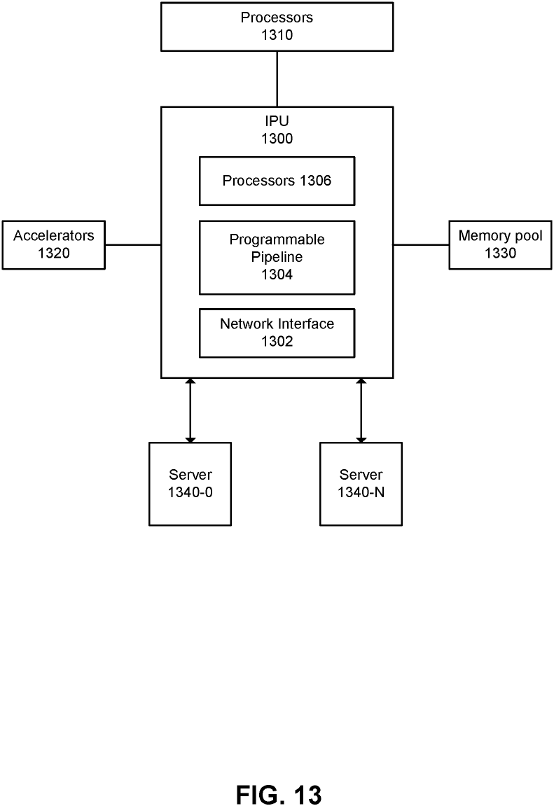

FIG. 13 depicts an example system. In this system, IPU 1300 manages performance of one or more processes using one or more of processors 1306, processors 1310, accelerators 1320, memory pool 1330, or servers 1340-0 to 1340-N, where N is an integer of 1 or more. In some examples, processors 1306 of IPU 1300 can execute one or more processes, applications, VMs, containers, microservices, and so forth that request performance of workloads by one or more of: processors 1310, accelerators 1320, memory pool 1330, and/or servers 1340-0 to 1340-N. IPU 1300 can utilize network interface 1302 or one or more device interfaces to communicate with processors 1310, accelerators 1320, memory pool 1330, and/or servers 1340-0 to 1340-N. IPU 1300 can utilize programmable pipeline 1304 to process packets that are to be transmitted from network interface 1302 or packets received from network interface 1302.

Programmable pipeline 1304 can include one or more packet processing pipeline that can be configured to perform match-action on received packets to identify packet processing rules and next hops using information stored in a ternary content-addressable memory (TCAM) tables or exact match tables in some embodiments. Programmable pipeline 1304 can include one or more circuitries that perform match-action operations in a pipelined or serial manner that are configured based on a programmable pipeline language instruction set. Processors, FPGAs, other specialized processors, controllers, devices, and/or circuits can be used utilized for packet processing or packet modification. For example, match-action tables or circuitry can be used whereby a hash of a portion of a packet is used as an index to find an entry. Programmable pipeline 1304 can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Programmable pipeline 1304 and/or processors 1306 can be configured to generate and provide virtual device interfaces to a virtual device interface subsystem (e.g., ADI subsystem) as well as intercept path operations, as described herein.

Configuration of operation of programmable pipeline 1304, including its data plane, can be programmed based on one or more of: one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries, or others.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Example 1 includes one or more examples and includes an apparatus comprising: a network interface device comprising: processor circuitry and circuitry configured to generate at least one virtual device interface to utilize the processor circuitry and provide the at least one virtual device interface to a server to assign to a process to provide the process with capability to utilize the processor circuitry.

Example 2 includes one or more examples, wherein the processor circuitry is to perform one or more of local area network access, cryptographic processing, and/or storage access.

Example 3 includes one or more examples, wherein the storage access comprises access to one or more Non-volatile Memory Express (NVMe) devices.

Example 4 includes one or more examples, wherein the circuitry configured to generate at least one virtual device interface is to perform a Virtual Device Composition Module (VDCM), wherein the VDCM is consistent with Open Compute Project Scalable IOV (SIOV).

Example 5 includes one or more examples, wherein the at least one virtual device interface comprises at least one assignable device interface (ADI), wherein the at least one ADI is consistent with Open Compute Project Scalable IOV (SIOV).

Example 6 includes one or more examples, wherein the network interface device comprises circuitry configured to perform intercepted path operations consistent with Open Compute Project Scalable IOV (SIOV), wherein the intercepted path operations comprise one or more of: device management operations, device initialization, device control, device configuration, quality of service (QoS) handling, error processing, and/or device reset.

Example 7 includes one or more examples and includes a server communicatively coupled to the network interface device, wherein the server comprises at least one processor configured to assign the at least one virtual device interface to the process.

Example 8 includes one or more examples, wherein the assign the at least one virtual device interface to the process is consistent with an Assignable Device Interfaces (ADI) subsystem of Open Compute Project Scalable IOV (SIOV).

Example 9 includes one or more examples, wherein the network interface device comprises one or more of: network interface controller (NIC), SmartNIC, router, forwarding element, infrastructure processing unit (IPU), or data processing unit (DPU).

Example 10 includes one or more examples and includes a computer-readable medium comprising instructions stored thereon, that if executed by one or more processors, cause the one or more processors to: in kernel space: receive at least one virtual device interface to a processor circuitry of a device from the device and assign the at least one virtual device interface to a process to provide the process with capability to utilize the processor circuitry of the device.

Example 11 includes one or more examples, wherein the device comprises one or more of: a network interface device, a storage controller, memory controller, fabric interface, processor, and/or accelerator device.

Example 12 includes one or more examples, wherein the processor circuitry is to perform one or more of local area network access, cryptographic processing, and/or storage access.

Example 13 includes one or more examples, wherein the at least one virtual device interface is generated by a Virtual Device Composition Module (VDCM) executed by the device, wherein the VDCM is consistent with Open Compute Project Scalable IOV (SIOV).

Example 14 includes one or more examples, wherein the at least one virtual device interface comprises at least one assignable device interface (ADI), wherein the at least one ADI is consistent with Open Compute Project Scalable IOV (SIOV).

Example 15 includes one or more examples, wherein the assign the at least one virtual device interface to the process is consistent with an Assignable Device Interfaces (ADI) subsystem of Open Compute Project Scalable IOV (SIOV).

Example 16 includes one or more examples and includes a method comprising: a network interface device: generating at least one virtual device interface to utilize processor circuitry of the network interface device and providing the at least one virtual device interface to a server to assign to a process to provide the process with capability to utilize the processor circuitry.

Example 17 includes one or more examples, wherein the processor circuitry is to perform one or more of local area network access, cryptographic processing, and/or storage access.

Example 18 includes one or more examples, wherein the generating at least one virtual device interface comprises performing a Virtual Device Composition Module (VDCM), wherein the VDCM is consistent with Open Compute Project Scalable IOV (SIOV).

Example 19 includes one or more examples, wherein the at least one virtual device interface comprises at least one assignable device interface (ADI), wherein the at least one ADI is consistent with Open Compute Project Scalable IOV (SIOV).

Example 20 includes one or more examples and includes the network interface device performing intercepted path operations consistent with Open Compute Project Scalable IOV (SIOV), wherein the intercepted path operations comprise one or more of: device management operations, device initialization, device control, device configuration, quality of service (QoS) handling, error processing, and/or device reset.

What is claimed is:

1. An apparatus comprising:
a network interface device comprising:
processor circuitry and
circuitry configured to generate at least one virtual device interface to utilize the processor circuitry and provide the at least one virtual device interface to a server to assign to a process to provide the process with capability to utilize the processor circuitry.

2. The apparatus of claim 1, wherein the processor circuitry is to perform one or more of local area network access, cryptographic processing, and/or storage access.

3. The apparatus of claim 2, wherein the storage access comprises access to one or more Nonvolatile Memory Express (NVMe) devices.

4. The apparatus of claim 1, wherein the circuitry configured to generate at least one virtual device interface is to perform a Virtual Device Composition Module (VDCM), wherein the VDCM is consistent with Open Compute Project Scalable IOV (SIOV).

5. The apparatus of claim 1, wherein the at least one virtual device interface comprises at least one assignable device interface (ADI), wherein the at least one ADI is consistent with Open Compute Project Scalable IOV (SIOV).

6. The apparatus of claim 1, wherein the network interface device comprises circuitry configured to perform intercepted path operations consistent with Open Compute Project Scalable IOV (SIOV), wherein the intercepted path operations comprise one or more of: device management operations, device initialization, device control, device configuration, quality of service (QoS) handling, error processing, and/or device reset.

7. The apparatus of claim 1, comprising a server communicatively coupled to the network interface device, wherein the server comprises at least one processor configured to assign the at least one virtual device interface to the process.

8. The apparatus of claim 1, wherein the assign the at least one virtual device interface to the process is consistent with an Assignable Device Interfaces (ADI) subsystem of Open Compute Project Scalable IOV (SIOV).

9. The apparatus of claim 1, wherein the network interface device comprises one or more of: network interface controller (NIC), SmartNIC, router, forwarding element, infrastructure processing unit (IPU), or data processing unit (DPU).

10. At least one non-transitory computer-readable medium comprising instructions stored thereon, that if executed by one or more processors, cause the one or more processors to:
in kernel space:
receive at least one virtual device interface to a processor circuitry of a device from the device and
assign the at least one virtual device interface to a process to provide the process with capability to utilize the processor circuitry of the device.

11. The computer-readable medium of claim 10, wherein the device comprises one or more of: a network interface device, a storage controller, memory controller, fabric interface, processor, and/or accelerator device.

12. The computer-readable medium of claim 10, wherein the processor circuitry is to perform one or more of local area network access, cryptographic processing, and/or storage access.

13. The computer-readable medium of claim 10, wherein the at least one virtual device interface is generated by a Virtual Device Composition Module (VDCM) executed by the device, wherein the VDCM is consistent with Open Compute Project Scalable IOV (SIOV).

14. The computer-readable medium of claim 10, wherein the at least one virtual device interface comprises at least one assignable device interface (ADI), wherein the at least one ADI is consistent with Open Compute Project Scalable IOV (SIOV).

15. The computer-readable medium of claim 10, wherein the assign the at least one virtual device interface to the process is consistent with an Assignable Device Interfaces (ADI) subsystem of Open Compute Project Scalable IOV (SIOV).

16. A method comprising:
a network interface device:
generating at least one virtual device interface to utilize processor circuitry of the network interface device and
providing the at least one virtual device interface to a server to assign to a process to provide the process with capability to utilize the processor circuitry.

17. The method of claim 16, wherein the processor circuitry is to perform one or more of local area network access, cryptographic processing, and/or storage access.

18. The method of claim 16, wherein the generating at least one virtual device interface comprises performing a Virtual Device Composition Module (VDCM), wherein the VDCM is consistent with Open Compute Project Scalable IOV (SIOV).

19. The method of claim 16, wherein the at least one virtual device interface comprises at least one assignable device interface (ADI), wherein the at least one ADI is consistent with Open Compute Project Scalable IOV (SIOV).

20. The method of claim 16, comprising:
the network interface device performing intercepted path operations consistent with Open Compute Project Scalable IOV (SIOV), wherein the intercepted path operations comprise one or more of: device management operations, device initialization, device control, device configuration, quality of service (QoS) handling, error processing, and/or device reset.
